(19) United States
(12) Patent Application Publication
(10) Pub. No.: US 2002/0069344 A1
(43) Pub. Date: Jun. 6, 2002

(54) Apparatus and method for data access control and instruction format therewith

(76) Inventors: Calvin Guey, Taipei Hsien (TW); Shyh-An Chi, Hsinchu (TW); Yu-Min Wang, Taichung (TW)

Correspondence Address: J.C. PATENTS INC., 4 VENTURE, SUITE 250, IRVINE, CA, 92618, US

(21) Appl. No.: 09/752,123

(22) Filed: Dec. 29, 2000

(30) Foreign Application Priority Data
Dec. 5, 2000 (TW) 89125860

(51) Int. Cl. G06F 15/00

(52) U.S. Cl. 712/34

(57) ABSTRACT

A coprocessor data access control method having a coprocessor memory access instruction with a coprocessor indicating field such that the quantity of word data to be transmitted between the coprocessor and the memory unit can be determined. The coprocessor indicating field actually includes a coprocessor number field and a coprocessor register field. The coprocessor number field indicates the particular coprocessor to be used while the coprocessor register field indicates the particular registers to be used.

### CROSS-REFERENCE TO RELATED APPLICATION

This application claims the priority benefit of Taiwan application serial no. 89125860, filed Dec. 5, 2000

### BACKGROUND OF THE INVENTION

1. Field of Invention

The present invention relates to an apparatus and a method for data access control and an instruction format therewith. More particularly, the present invention relates to an apparatus and a method for data access control and an instruction format therewith, in which one of coprocessor memory access instructions has an indicating field capable of determining the quantity of data words that can be transferred between the coprocessor and the memory.

2. Description of Related Art

Processor is currently one of the indispensable components in many electronic products. For example, each personal computer has a central processing unit (CPU) and a number of dedicated processors. Following the rapid progress in electronic technologies, processors having increasingly powerful functions are constructed.

Due to an increase demand of powerful processors, coprocessors are developed to process subsidiary items so that the main processor can work more efficiently and quickly.

Amongst the data access instructions of a main processor, some of the instructions are introduced specially to control data transmission between the coprocessor and a memory. Many data access control methods that deal with coprocessors have been invented. For example, in U S. Pat. No. 5,193,159 titled ‘Microprocessor System’, a 16 bit temporary register is used to control the number of data transmission. However, the method demands lots of chip area. In U.S. Pat. No, 6,002,881 titled ‘Coprocessor Data Access Control’, a portion of the addressing mode information of the coprocessor instructions is used to control the quantity of data to be transmitted. Yet, the method tends to use up many instruction bits just to retain transmission length information.

### SUMMARY OF THE INVENTION

Accordingly, one object of the present invention is to provide a coprocessor data access control method capable of using coprocessor memory access instructions that have a coprocessor register indicating field to determine the number of data words in a transmission between the coprocessor and the memory.

Another object of the invention is to provide a coprocessor data access control method capable of controlling data transmission quantity without an additional register or the need to occupy a portion of the fixed address mode information.

A further object of the invention is to provide a coprocessor data access control method that requires a smaller chip area. Moreover, many instruction bits that are originally taken up by coprocessor memory access instructions for transferring length information are freed up for other purposes.

To achieve these and other advantages and in accordance with the purpose of the invention, as embodied and broadly described herein, the invention provides an apparatus for coprocessor data access control, comprising a central processing unit, a memory unit and a coprocessor. The a central processing unit is used for executing central processing unit instructions to perform data processing. The central processing unit instructions includes a plurality of coprocessor memory access instructions. The memory unit, coupled to the central processing unit, is used for storing data words. The coprocessor, coupled to the central processing unit and the memory unit, is used for accessing and processing the data words stored in the memory unit by one of addressing modes under control of the coprocessor memory access instructions executed by the central processing unit. The coprocessor memory access instruction has an indicating field, and N data words are accessed to or from the memory unit by the coprocessor according to the value of the indicating field. The N is a value greater than or equal to 1.

In the apparatus for coprocessor data access control as described above, the indicating field of the coprocessor memory access instruction includes a coprocessor number field and/or a coprocessor register field. The coprocessor number field is used for storing information about a specific coprocessor to be activated. The coprocessor register field is used for storing information about specific registers to be used in the data processing.

To achieve these and other advantages and in accordance with the purpose of the invention, as embodied and broadly described herein, the invention provides a coprocessor data access control method, comprising the steps of: providing an instruction having an indicating field; and accessing N data words to or from a memory unit by a specified coprocessor according to the value in the coprocessor indicating field, wherein N is a value greater than or equal to 1, and the number of word data depends on the value in the coprocessor number field and/or the value in the coprocessor register field.

In the method for coprocessor data access control as described above, the indicating field of the coprocessor memory access instruction includes a coprocessor number field and/or a coprocessor register field. The coprocessor number field is used for storing information about a specific coprocessor to be activated. The coprocessor register field is used for storing information about specific registers to be used in the data processing.

To achieve these and other advantages and in accordance with the purpose of the invention, as embodied and broadly described herein, the invention provides an instruction format for a coprocessor data access control. The instruction format includes an indicating field, and a particular coprocessor to be used and the number of data words to be accessed to/from a memory unit is determined by the value of in the indicating field.

In the instruction format described above, the indicating field of the coprocessor memory access instruction includes a coprocessor number field and/or a coprocessor register field. The coprocessor number field is used for storing information about a specific coprocessor to be activated. The coprocessor register field is used for storing information about specific registers to be used in the data processing.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram showing the architectural arrangement of a microprocessor and a coprocessor capable of implementing a coprocessor data access control method according to this invention; and

FIG. 2 is a diagram showing an instruction format for a coprocessor according to this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

This invention provides an apparatus and a method for data access control adapted in a main processor and a coprocessor (CP). The apparatus and method use a specific instruction format according to a preferred embodiment of the invention. In the invention, an indicating field of a coprocessor memory access instruction is introduced to determine the quantity of data words to be transmitted between the coprocessor and a memory. The so-called indicating field actually includes a coprocessor number field and/or a coprocessor register field. The coprocessor number field stores information about the particular coprocessor to be activated and the coprocessor register field stores information about what particular registers to be used in a transaction.

According to the embodiment of this invention, each coprocessor has a fixed function under a normal operating mode. In other words, each coprocessor will access or retrieve a fixed-length words from the memory according to the value in the coprocessor number field and/or the coprocessor register field. Hence, data transmission quantity is controlled without the need for an additional register or the need to occupy a portion of the address mode information in the instruction. Moreover, chip area can be reduced and many instruction bits that are originally taken up by coprocessor memory access instructions for transferring length information can be freed up for other purposes.

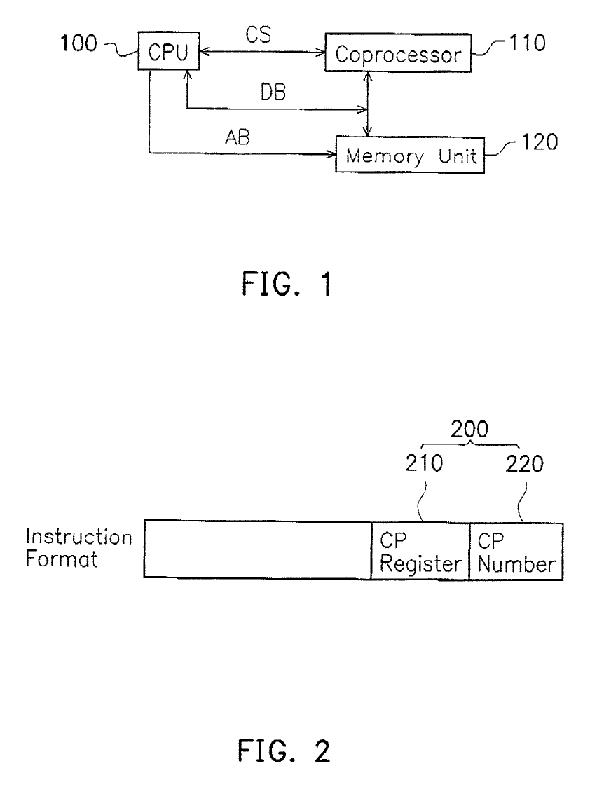

FIG. I is a diagram showing the architectural arrangement of a microprocessor and a coprocessor capable of implementing a coprocessor data access control method according to this invention. As shown in FIG. 1, the architecture principally includes a central processor unit (CPU) 100, a coprocessor 110 and a memory unit 120. The memory unit 120 includes cache memory and additional types of memories. The CPU 100 is used for executing central processing unit instructions to perform data processing. The central processing unit instructions includes the coprocessor memory access instructions. The coprocessor 110 is coupled to CPU 100 and the memory unit 120. The coprocessor 110 accesses and processes data words stored in the memory unit 120, addressed by one of addressing modes under control of the coprocessor memory access instructions executed by the CPU 100.

At first, it is noted that in the preferred embodiment of the invention, only one coprocessor 110 is introduced in FIG. 1. However, the invention is also applicable to an architectural arrangement of a microprocessor and several coprocessors. These coprocessors can support data processing for the CPU 100.

When the central processing unit 100 starts to fetch instructions from the memory unit 120, the CPU 100 will issue an address to the address bus (AB). The memory unit 120 retrieves the required instruction and put on the data bus (DB) according to the address on the address bus (AB). The central processing unit 100 and the coprocessor 110 will inspect the instruction simultaneously. If the instruction is a coprocessor memory access instruction, the coprocessor 110 can determine the quantity of word data to be transmitted between the coprocessor 110 and the memory unit 120 according to the instruction.

FIG. 2 is a diagram showing an instruction format for a coprocessor according to a preferred embodiment of the invention. The instruction format includes an indicating field 200. The indicating field 200 includes a coprocessor number field (CP number) 220, or a coprocessor register field (CP Register) 210, or both. The coprocessor number field 220 stores information about a specific coprocessor to be activated, for example, each value of the coprocessor number field 220 has a corresponding coprocessor to be activated. The coprocessor register field 210 stores information about specific registers to be used in the data processing, for example, each value of the coprocessor register field 210 has a corresponding number of registers to be used in the data transmission.

Such a design originates from the criteria that each coprocessor has a fixed function under a normal operating mode. In other words, each coprocessor accesses a fixed-length word data from a memory unit or a specified register. For example, according to the value in the coprocessor number field 220, a corresponding coprocessor can be selected. According to the value in the coprocessor number field 220 and/or the coprocessor register field 210, the number of registers required and/or the number of word data that needs to be transmitted can be determined.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for coprocessor data access control, comprising
a central processing unit, for executing central processing unit instructions to perform data processing, wherein the central processing unit instructions includes a plurality of coprocessor memory access instructions;
a memory unit, coupled to the central processing unit, for storing data words; and
a coprocessor, coupled to the central processing unit and the memory unit, for accessing and processing the data words stored in the memory unit by one of addressing modes under control of the coprocessor memory access instructions executed by the central processing unit, wherein
the coprocessor memory access instruction having an indicating field, and N data words are accessed to or from the memory unit by the coprocessor according to the value of the indicating fields wherein N is a value greater than or equal to 1.

2. The apparatus for coprocessor data access control as claimed in claim 1, wherein the indicating field of the coprocessor memory access instruction includes a coprocessor number field, for storing information about a specific coprocessor to be activated.

3. The apparatus for coprocessor data access control as claimed in claim 1, wherein the indicating field of the coprocessor memory access instruction includes a coprocessor register field, for storing information about specific registers to be used in the data processing.

4. The apparatus for coprocessor data access control as claimed in claim 1, wherein the indicating field of the coprocessor memory access instruction includes a coprocessor number field and a coprocessor register field, wherein coprocessor number field is used for storing information about a specific coprocessor to be activated, and the coprocessor register field is used for storing information about specific registers to be used in the data processing.

5 A coprocessor data access control method, comprising the steps of:
providing an instruction having an indicating field; and
accessing N data words to or from a memory unit by a specified coprocessor according to the value in the coprocessor indicating field, wherein N is a value greater than or equal to 1, and the number of word data depends on the value in the coprocessor number field and/or the value in the coprocessor register field.

6. The method for coprocessor data access control as claimed in claim 5, wherein the indicating field of the coprocessor memory access instruction includes a coprocessor number field, for storing information about a specific coprocessor to be activated.

7. The method for coprocessor data access control as claimed in claim 5, wherein the indicating field of the coprocessor memory access instruction includes a coprocessor register field, for storing information about specific registers to be used in the data processing.

8. The method for coprocessor data access control as claimed in claim 5, wherein the indicating field of the coprocessor memory access instruction includes a coprocessor number field and a coprocessor register field, wherein coprocessor number field is used for storing information about a specific coprocessor to be activated, and the coprocessor register field is used for storing information about specific registers to be used in the data processing.

9. An instruction format for a coprocessor data access control, wherein the instruction format includes an indicating field, and a particular coprocessor to be used and the number of data words to be accessed to or from a memory unit is determined by the value of in the indicating field.

10. The instruction format of claim 9, wherein the indicating field of the instruction format is a coprocessor number field.

11. The instruction format of claim 9, wherein the indicating field of the instruction format is a coprocessor register field.

12. The instruction format of claim 9, wherein the indicating field of the coprocessor memory access instruction includes a coprocessor number field and a coprocessor register field, wherein coprocessor number field is used for storing information about a specific coprocessor to be activated, and the coprocessor register field is used for storing information about specific registers to be used in the data processing.
